(19) United States
(12) Patent Application Publication
(10) Pub. No.: US 2012/0189173 A1
(43) Pub. Date: Jul. 26, 2012

(54) IMAGE DISPLAY

(76) Inventors: H. Toby MARKOWITZ, Roseville, MN (US); Lane PHILLIPS, Saint Paul, MN (US); Victoria Lynn INTERRANTE, Minneapolis, MN (US)

(21) Appl. No.: 13/014,478

(22) Filed: Jan. 26, 2011

(51) Int. Cl. G06K 9/00

(52) U.S. Cl. 382/128

(57) ABSTRACT

A medical imaging system having a medical image capture device; a medical measurement device; a display coupled to the image capture device and the medical measurement device, the display displaying: a medical image obtained from the medical image capture device; a medical measurement obtained from the medical measurement device, the medical measurement segmenting the medical image on the display; and a border substantially surrounding the medical measurement, the border defining a region of the display excluding the medical image.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to medical imaging and display systems, and in particular, towards systems and methods of use thereof for efficiently and conveniently displaying information from multiple sources.

### BACKGROUND OF THE INVENTION

In modern medicine, a considerable number of interventional procedures have been developed and typically require physiologic monitoring of a patient using various imaging techniques and diagnostic instrumentation. Indeed, image guided procedures employing visual displays to guide and assist a physician operator are commonplace in the interventional laboratories and operating theaters. A variety of instrumentation modalities provide images to guide interventional procedures. In some situations, images are acquired prior to the interventional procedure or treatment. Other approaches involve acquiring images at the beginning of the procedure, while still some other procedures involve the acquisition of data in real-time.

Commonly used instrumentation modalities used to image patient anatomy and physiology include 1) X-ray (radiation transmitted through a body and received with a sensor to produce an image), 2) fluoroscopy (an x-ray variant), 3) computerized tomography (“CT,” where an x-ray source and detector are rotated around a patient to provide multiple images with a longitudinal scan for subsequent image reconstruction), 4) magnetic resonance imaging (“MRI,” employing certain magnetic and electromagnetic fields and produces images based on the spin of electrons within bodily tissues), and 5) echo (utilizes the transmission of ultrasonic (acoustic) waves and produces images based on reflected waves from target tissues). Echo systems may be applied from outside the patient or may be delivered through a catheter for use within a patient.

In addition to imaging, various physiological parameters are often monitored during an interventional procedure. For example, such physiological monitoring may include the use of 1) an electrocardiogram (“ECG,” an electrical measuring device that uses a plurality of electrodes attached to the body of a patient), 2) blood pressure monitoring via pressure sensors attached externally or to catheters indwelling in a patient, 3) blood oxygenation sensors that may be attached externally and shine light into an extremity, 4) various sensors for use in monitoring the respiration of the patient, and 5) monitors for other bodily functions that may be appropriate for a particular patient and procedure.

Coupled with image acquisition and physiological assessment techniques, advances in display technology have created an abundance of large, easily readable multi-color displays. Though modern day interventional laboratories and operating theaters routinely contain a plethora of displays, providing multiple displays has the disadvantage of distracting the physician operator from the interventional procedure and, ultimately, the care of the patient. Moreover, space is at a premium in interventional laboratories, so extending a user interface to additional displays demands more space, incurs more cost, and may not be generally practical.

Efforts to minimize operator distraction (and the cost and space taken) associated with a multiple-display system have included combining information on a display (or on a lesser-plurality of displays) by partitioning each display into compartmentalized display areas each providing particular information. By allocating visible display area, or pixels, to each image or information source, the physician operator becomes accustomed to viewing specific areas of each display to find the specific information that is allocated to that area. Unfortunately, such allocation results in a small area for each information and consequently, a small display of each information. Even with a physically large display, the allocation and reservation of specific pixels for specific information diminishes the viewing area that might otherwise be possible for each specific item of information. Difficulties arise when the viewing area for each item is too small to be easily legible, especially in the setting of an interventional procedure where the display might be located some distance from the physician operator. Another approach may include selectively displaying a subset of available information through a user interface. This approach, unfortunately, requires a physician operator to divert even more attention to manage the medical instrumentation and the selection of information to be displayed at any given time.

In view of the above, it is desirable to provide systems and methods of use thereof for the display of multiple patient signals or information sources in a convenient and readily-legible manner.

### SUMMARY OF THE INVENTION

A method for displaying medical information is provided, including displaying a first image of at least one of anatomical and physiological information on a display; displaying a second image on the display, at least a portion of the second image traversing at least a portion of the first image; and displaying a boundary on the display between the first image and the second image, where the second image and the boundary may each be displayed in a different color. The boundary may be symmetrically disposed about the second image and/or may include a region of the display where a portion of the first image has been excluded. The second image may include physiological information; a plurality of values taken over time; a blood pressure measurement; a blood-oxygen concentration measurement; an electrocardiogram; and/or an electrogram. The second image may include a plurality of values, and displaying the second image may include displaying a first value of the plurality of values in a first position on the display; removing the first value from the first position; displaying a second value of the plurality of values in the first position; and displaying the first value in a second position on the display. Displaying the boundary may include changing a position of at least a portion of the boundary in synchronization with the position of the plurality of values on the display. The method may include comprising capturing at least one of anatomical and physiological information with a minimally invasive medical device and/or displaying instrumentation information on the display.

A medical display system is provided, including a display having a plurality of pixels; a first plurality of the pixels displaying medical image data; a second plurality of the pixels displaying trace signal data, and a third plurality of the pixels disposed between the first and second pluralities of pixels, the third plurality of pixels excluding the medical image data. The third plurality of pixels may be symmetrically disposed about the second plurality of pixels and the trace signal data may include a measurement of cardiac electrical activity. The second plurality of pixels may have a width of approximately three pixels, and the third plurality of pixels may have a width of approximately ten pixels. The second plurality of pixels may divide the first plurality of pixels into two separate sections. The system may include an image acquisition device coupled to the display and/or a physiological assessment device coupled to at least one of the display and the image acquisition device, where at least one of the image acquisition device and the physiological assessment device includes a catheter having an electrode. The system may include a fourth plurality of the pixels displaying a background, where the third plurality of pixels and the fourth plurality of pixels have substantially the same color.

A medical imaging system is provided, including a medical image acquisition device; a physiological assessment device; a display coupled to the medical image acquisition device and the physiological assessment device, the display displaying: a medical image obtained from the medical image acquisition device; a physiological measurement obtained from the physiological assessment device, the physiological measurement segmenting the medical image on the display; and a border substantially surrounding the physiological measurement, the border defining a region of the display excluding the medical image. The display may display a background, and the background and the border may have substantially the same color. The medical image may include a portion of a heart.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of an exemplary embodiment of a medical imaging system constructed in accordance with the principles of the present invention;

FIG. 2 is an illustration of an exemplary display of the system in FIG. 1;

FIG. 3 is shows a magnified portion of the display of FIG. 2; and

FIG. 4 is a flow chart of an exemplary method for displaying medical images and data.

### DETAILED DESCRIPTION OF THE INVENTION

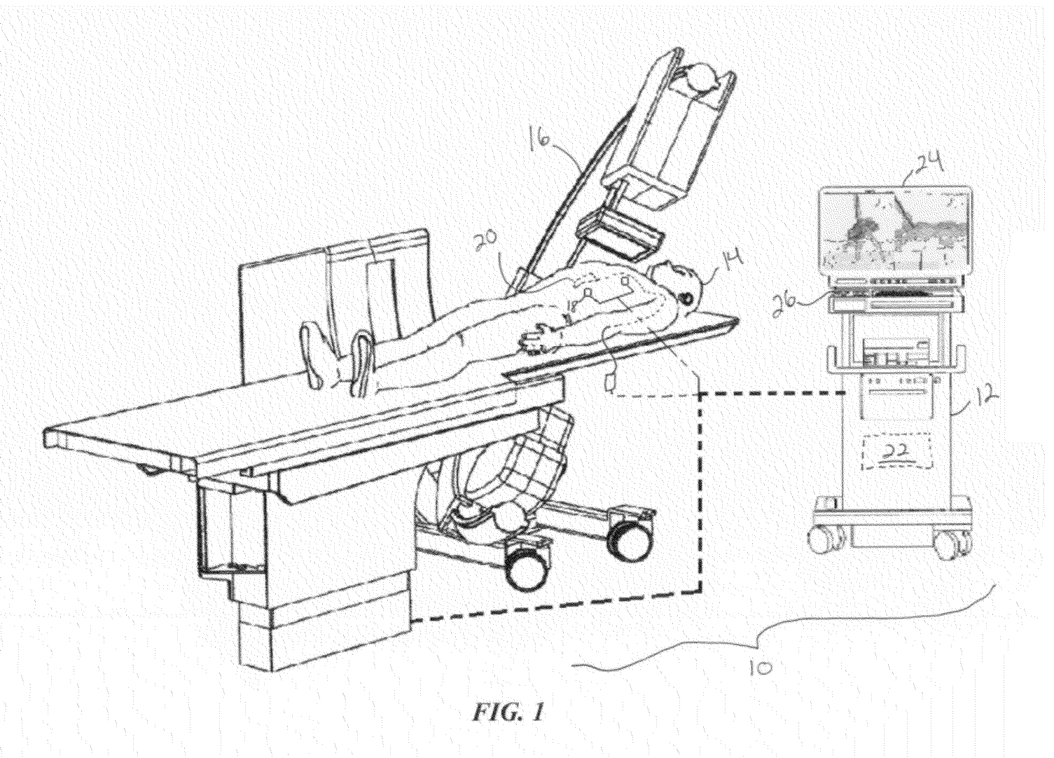

The present invention provides systems and methods of use thereof for the display of multiple patient signals or information sources in a convenient and readily-legible manner. Now referring to the drawings in which like reference designators refer to like elements there is shown in FIG. 1 an embodiment of a medical imaging system referred to generally as “10.” The system 10 may generally include a system control/processing unit 12 and one or more devices operable to acquire, measure, monitor or otherwise convey information regarding a patient 14 to the control unit 12 and vice versa.

For example, the system 10 may include one or more image capture or acquisition devices 16 external to the patient 14 and in communication with the control unit 12. Examples of such image capture and acquisition devices 16 may include an X-ray, fluoroscopic, or computed tomography (“CT”) device. The image acquisition device(s) 16 may also include, for example, a magnetic resonance imaging (“MRI”) device, an ultrasound/acoustic device, or the like that capture, measure, or otherwise obtain anatomical information (e.g., information regarding a structure of the patient) and/or physiological information (e.g., information regarding processes, functions, conditions, or activities) of the patient 14.

The system 10 may include one or more physiological assessment devices 18 coupled to or positionable about an exterior of the patient 14 and in communication with the control unit 12. The one or more physiological assessment devices 18 generally measures, monitors or records a physiologic state or condition of the patient 14. For example, the physiological monitoring device(s) 18 may include one or more electrodes or sensors placed on an exterior of the patient 14 to record an electrogram (“EGM”) of electrical activity on or about a portion of the patient 14. As used herein, the term electrogram is referred to as a recording or measurement of changes in electric potential. A specific example of an electrogram may be the recording and/or processing of an electrocardiogram (“ECG”) signal trace using a plurality of electrodes or leads placed on the skin of the patient 14. Various other electrograms may also be obtained by the physiological monitoring/measuring device 18, including, for example, intracardiac electrograms indicative of an arrhythmia loci, electric potential changes in a particular chamber of the heart or in proximity to the His bundle, esophageal electrograms, or the like. Other examples of physiological assessment devices 18 may include (but are not limited to) blood oxygenation measuring devices, blood pressure measurement devices, blood flow measuring devices (e.g., a device measuring or monitoring flow direction and magnitude, Doppler ultrasound, etc.), temperature monitoring devices, and/or respiration/respiratory rate monitoring devices.

The system 10 may include one or more minimally-invasive or interventional medical devices 20 positionable within a portion of the patient 14 to acquire anatomical or physiological information, or to otherwise diagnose or treat the patient 14. The medical device(s) 20 may be coupled to the control unit 12, which may communicate operational procedures and protocols dictating the operation of the medical device 20 as well as receiving feedback from the medical device 20 regarding the designated procedure, treatment, or the like with respect to the patient 14. The medical device(s) 20 may include a catheter having one or more diagnostic or treatment elements that is insertable into the patient 14 through a small incision and routed to a desired region of the patient 14 through a vascular channel, for example. The treatment elements on the catheter may include, for example, one or more temperature, pressure, or electrical activity sensors facilitating information acquisition, diagnoses, or treatment procedures. The medical device may be operable to obtain one or more electrograms from an interior of the patient 14, as well as blood pressure, temperature, oxygenation, and the like described above. Another example of the medical device 20 may include an endoscope having a video capture assembly on it to obtain images of an internal region of the patient 14. Other specific examples of the medical device 20 may include pacing catheters, ablation catheters, fluid delivery catheters (e.g., to deliver pharmaceutical compounds, imaging contrast fluids, etc.), and the like.

Continuing to refer to FIG. 1, the system 10 control/processing unit 12 is coupled to one or more of the image capture or acquisition device(s) 16, physiological assessment devices 18, and/or interventional medical devices 20 described above. The control unit 12 may be used to receive and/or process information communicated from the attached devices 16, 18, 20 as well as send operational commands or signals to the devices during their use. The coupling and communication between the control unit 12 and the devices may be achieved through a direct wired connection or through wireless communication protocols as known in the art. The control unit 12 may include one or more controllers, processors, and/or software modules containing instructions or algorithms to provide for the automated operation and performance of the devices, features, sequences, calculations, or procedures described herein. The control unit 12 may include electronic storage media 22 retaining information regarding the operation of the control unit 12 and/or the devices 16, 18, 20, including stored anatomical and/or physiological information previously obtained from a patient 14.

The system 10 may include a display 24 in communication with the control unit 12 to provide visual information regarding the attached devices 16, 18, 20 and/or patient 14, as well as one or more user controls 26 facilitating operation of one or more aspects of the control unit 12 and the devices. The display 24 can include, for example, a cathode ray tube (“CRT”), liquid crystal display 24 (“LCD”), or other visual interface generally including a plurality of pixels or segmented display 24 elements for visualizing information from the control unit 12 and/or coupled devices. The display 24 may be touch-screen operable and may be removable or releasable from the control unit 12 for ease of use and view. Alternatively, the display 24 may be integrated with the control unit 12 in a portable tablet device.

The system 10 may further provide for the manipulation of designated images and/or information provided on the display 24. The selection, manipulation, processing, and/or visualization of the selected characteristics or configurations of the images and information on the display 24 may be achieved through manipulation of the user controls 26 and the programming/processing components of the control unit 12. Such selective manipulation may include adjusting, rotation, panning, or zooming selected portions of one or more images on the display 24.

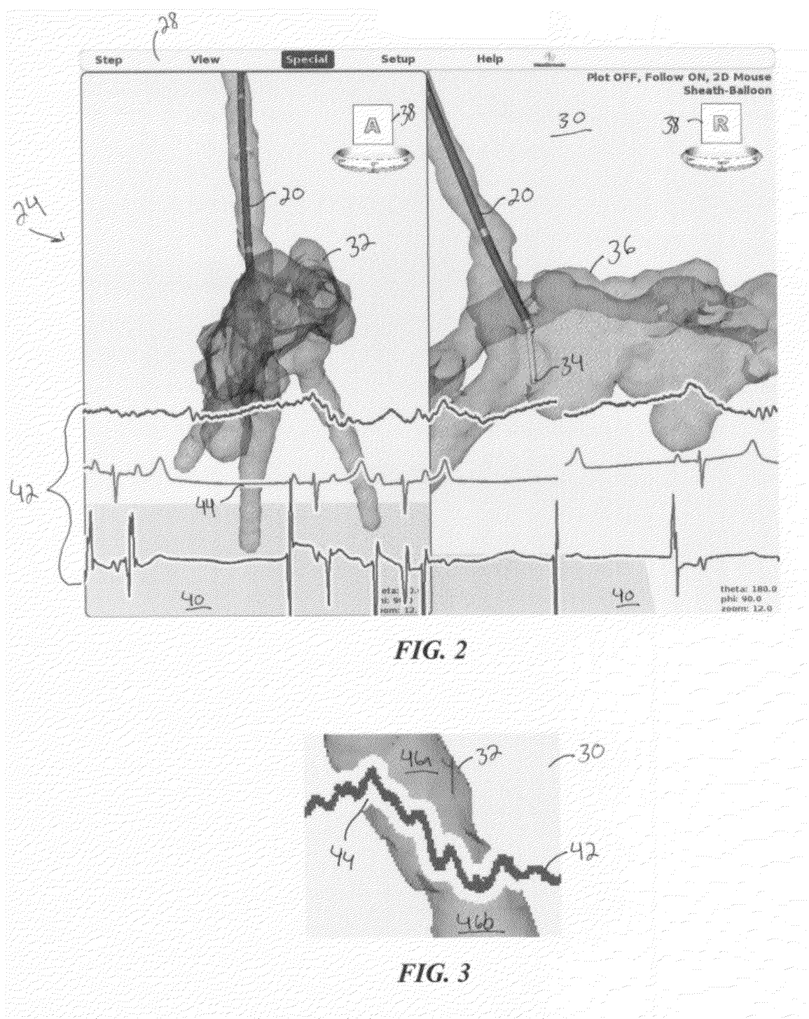

Now referring to FIG. 2, an exemplary visual presentation of medical information on the display 24 is shown. The display 24 may generally include a menu bar 28 indicating available options and other selectable components related to the control unit 12, the display 24, and/or the coupled device(s) 16, 18, 20. The display 24 may further include a background 30 as a contrasting backdrop against which other images or information is displayed.

The display 24 may include a first plurality of pixels displaying a first image 32 produced at least in part from information received from one or more of the image acquisition devices 16, the physiological assessment devices 18, and/or the medical devices 20. The information resulting in the first image 32 may be acquired from the patient 14 and displayed in substantially real-time and/or displayed from previously-obtained information recalled from the storage media 22 of the control unit 12. The first image 32 may include a graphical reproduction or illustration of an anatomical structure or region of the patient 14, such as the heart, and may take up a substantial portion of the display 24 for ease of viewing and reference to an operator. The first image 32 may also include one or more medical devices 20 having one or more diagnostic and/or treatment elements 34 (such as those described above) in proximity to the displayed anatomical structure.

The display 24 may provide multiple images having different viewpoints or orientations of the same anatomical or physiological construct. For example, a second image 36 may be displayed with a second plurality of pixels, where the second image 36 is an alternative orientation of the first image 32. As shown in FIG. 2, the first image 32 may include an anterior-posterior view of the illustrated structure, while the second image 36 may include an illustration of the same anatomical structure in a right lateral view. Of course, other viewpoints may be provided on the display 24, and the display 24 may include a reference indicator or indicia 38 signifying the viewpoint from which the first and second images are shown. The display 24 may further include the illustration of a plane of reference 40 to aid a user in recognizing the illustrated orientation of the images at any given time. The imaged plane of reference 40 may be, for example, one of the customary sagittal, coronal, and/or transverse anatomical planes and may align with one of the physiological assessment device(s) 18, image capture device(s) 16 or medical device(s) 20.

The display 24 may also include a third plurality of pixels showing a third image 42 produced at least in part from information received from one or more of the image acquisition devices 16, the physiological assessment devices 18, and/or the medical devices 20. The third image 42 may include a graphical reproduction or illustration of one or more values corresponding to a physiological assessment, measurement, or monitored condition. For example, the third image 42 may include one or more signal traces or visual indicators corresponding to an ECG, EGM, blood pressure and/or oxygen concentration of the patient 14. The third image 42 may include an image or information related to instrumentation use or status. For example, the third image 42 may include one or more indications of treatment duration, information regarding expected or actual operational parameters of a one of the image acquisition devices 16, the physiological assessment devices 18, and/or the medical devices 20 (e.g., temperature measurements and thresholds of a device; electrical connection or sensor status and activity of a device, “ON” or “OFF”, etc.). The third image 42 may consist of one or more signal traces or indications of the monitored or measured information, including a periodically-updated image or graphic that streams or sweeps across a portion of the display 24 as the information contributing to the third image 42 is updated or acquired. At least a portion of the third image 42 may traverse a portion of the first and/or second images 32, 36, or the plane of reference 40. On the portion of the display 24 where the third image 42 traverses, intersects or would otherwise be in the same position on the display 24 as part of the first and/or second images, the third image 42 may visually dominate or appear to overwrite the traversed portion of the first and/or second images 32, 36, as described in more detail below.

Now referring to FIGS. 2-3, the display 24 may further include a fourth plurality of pixels providing a boundary or “halo” 44 disposed between at least a portion of the third image 42 and the first image 32, second image 36, and/or the illustrated plane of reference 40. For example, the boundary 44 may substantially surround or extend along a portion of the third image 42 that traverses the first and/or second images to provide a contrasting buffer between the images to ease viewing and more readily allow an operator to distinguish between the image content. The displayed boundary 44 may generally exclude image information that would otherwise be displayed as part of the first and/or second images, and may include a color or visual presentation substantially similar to the background 30. As a result, the boundary 44 and the third image 42 may divide or partition the first and/or second images 32, 36 into separate image segments 46a, 46b. Where the boundary 44 extends across a substantial length or dimension of the third image 42 and is substantially similar to the background 30, its presence may not be readily visually apparent in regions of the display 24 where the third image 42 does not traverse any portion of another displayed image or information. Alternatively, the boundary 44 may be generated in only those regions where the third image 42 traverses a portion of another image or displayed information.

The boundary 44 may be symmetrically disposed about a portion of the third image 42, and may be continuously updated or positionally oriented about the third image 42 in synchronization with updates or changes to the third image 42. For example, if the third image 42 has a width of approximately 3 pixels, the boundary 44 may have a total width of approximately 10 pixels, with 3.5 pixels on either side of the third image 42 constituting the visually perceptible boundary. The boundary 44 may have a substantially uniform thickness extending from the third image 42 to minimize the amount of space needed on the display 24 to show multiple traversing images while maintaining an adequate contrast between the multiple images. Alternatively, the boundary 44 may have a substantially fixed width between two substantially parallel lines or edges encompassing the third image 42, with the distance between an edge of the third image 42 and an edge of the boundary 44 varying across different positions on the display 24. Of course, variations in thickness and dimensions of the images and boundary 44 may be varied and/or user-selectable as desired for specific applications.

A number of color variations and modifications may be implemented to accentuate or enhance the contrast between the images 32, 36, 42, the boundary 44, and/or the background 30. For example, the system 10 may include an operator-selectable range of brightness, contrast, color, or other forms of visual enhancement and/or modification of selected portions of the imagery provided on the display 24 to visually distinguish portions of one image from another. In a particular example, the background 30 of the display 24 may have a first color, such as pale blue, and the first, second, and/or third images may include one or more colors that contrast with the first color, such as red or green for example.

The system 10 may employ different shades of that color to denote depth, curvatures or surface variations in the image. For example, shadows, hue and/or brightness may be employed to differentiate the ventricles, atria, or vasculature in or around an imaged heart. A shadow or other image enhancements, for example, a blending of the third image color into the color of the boundary 44, may also be displayed.

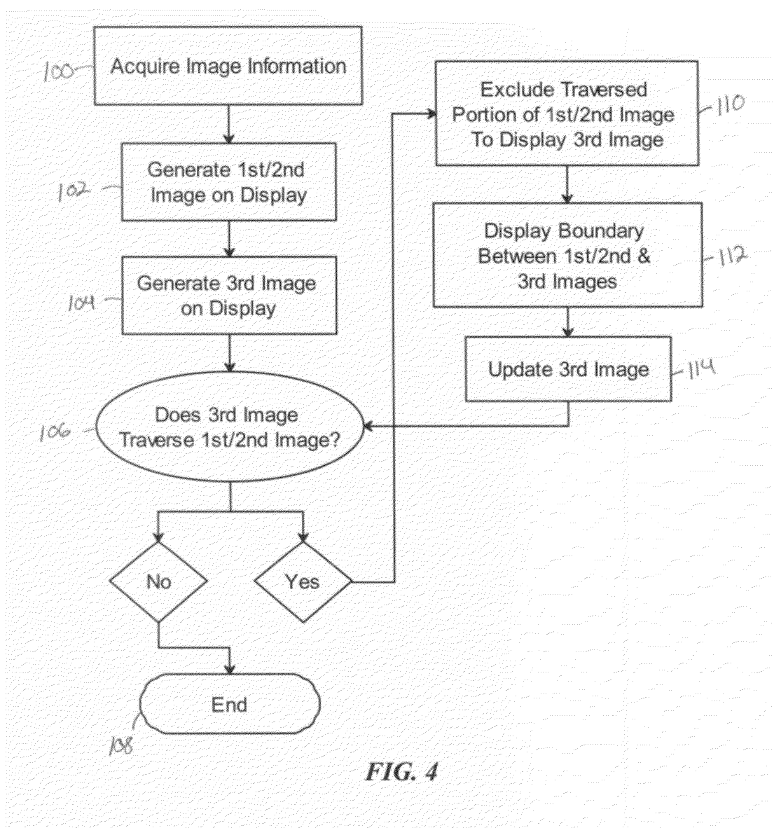

Now referring to FIG. 4, a method of providing images on the display 24 is shown. Primarily, information sufficient to generate an image may be acquired from one or more of the image acquisition devices 16, the physiological assessment devices 18, the medical devices 20, and/or recalled from the storage media 22 of the control unit 12 (Step 100). Once the imaging information has been acquired or loaded from storage, the information may be processed by the control unit 12 as needed to generate the first and/or second image 32, 36 on the display 24 (Step 102). As described above, the first and/or second images may include an anatomical structure and/or the positioning of a medical device. The system 10 may also generate the third image 42 on the display 24 (Step 104). As described above, the third image 42 may include physiological and/or instrumentation information, for example. The generation of the first, second and/or third images may result in a conflict between which information attributed to which image should be displayed in particular pixels or image segments of the display 24. For example, portions of the first, second, and/or third images may overlap or be “competing” for the same pixels on the display 24. An inquiry into whether portions of one or more of the generated images traverses portions of other images may be performed by the control unit 12 (Step 106). If there is no conflict or overlap, the inquiry is a “no,” and the images are displayed (“End,” Step 108). If a conflict between displaying image information or image overlap exists, the conflict is resolved by excluding or visually minimizing one portion of an image in favor of another image. The allocation of available pixels or regions of the display 24 may follow a selectable hierarchy amongst available image information, and the order or preference of which image(s) or information to display and which to exclude may be user selectable. In a particular example, the third image 42 may be the dominant or preferred image that is displayed while the conflicting or overlapping portions of the first and/or second images are removed or excluded from the display 24 (Step 110). The boundary 44 may be generated and displayed about one or more segments of the third image to provide visual contrast between the images (Step 112). The third image 42 may include periodically updated information or a plurality of values that are displayed on a portion of the display 24 (Step 114). For example, the third image 42 may be updated by deleting a portion or first value of the third image 42 from a first position on the display 24 and moving the first value to a second position. The update to the third image 42 may also include displaying a second value or portion in the first position. This process may be repeated with updated image information corresponding to values or information received during a designated time period or frequency. Updating or refreshing the third image 42 in this manner may provide a visual appearance of a substantially continuous, moving image or graphic sweeping across the display 24. As the information underlying the generation of the third image is updated, the inquiry into the image overlap or conflict and is repeated (Step 106).

Depending on the speed of updating or refreshing the third image 42, the portions of the first and/or second images 32, 36 that are obscured by the third image 42 may only be momentarily hidden from view. For example, if the third image includes 42 an ECG signal, the bulk of the third image 42 may have a substantially flat-line interrupted by the periodic waveform indicating the electrical activity associated with the heart. As the signal is updated with the erasure and/or repositioning of older data with newer data, the third image 42 may appear to move across the display 24 with minimal interference to effectively and accurately viewing the first and/or second images. This allows an operator to have essentially full viewing access to the first and/or second images, while still gleaning the important physiological or instrumentation information presented by the third image 42—all in substantially one region on the display 24, thereby negating the need for numerous additional displays or compartmentalization between the individually presented images in smaller regions of the display 24, and reducing the attention taken away from the patient 14 and procedure at hand.

It will be appreciated by persons skilled in the art that the present invention is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the system and devices disclosed herein are not necessarily exclusive of each other and may be included in a variety of different combinations or configurations. A variety of modifications and variations are possible in light of the above teachings without departing from the scope and spirit of the invention, which is limited only by the following claims.

What is claimed is:

1. A method for displaying medical information, comprising:
displaying a first image of at least one of anatomical and physiological information on a display;
displaying a second image on the display, at least a portion of the second image traversing at least a portion of the first image; and
displaying a boundary on the display between the first image and the second image.

2. The method of claim 1, wherein the boundary is symmetrically disposed about the second image.

3. The method of claim 1, wherein the boundary includes a region of the display where a portion of the first image has been excluded.

4. The method of claim 1, wherein the second image includes physiological information.

5. The method of claim 4, wherein the second image includes at least one of an electrocardiogram and an electrogram.

6. The method of claim 1, wherein the second image includes a plurality of values, and wherein displaying the second image includes:
displaying a first value of the plurality of values in a first position on the display;
removing the first value from the first position;
displaying a second value of the plurality of values in the first position; and
displaying the first value in a second position on the display.

7. The method of claim 6, wherein displaying the boundary includes changing a position of at least a portion of the boundary in synchronization with the position of the plurality of values on the display.

8. The method of claim 4, wherein the second image includes a plurality of values taken over time.

9. The method of claim 4, wherein the second image includes at least one of a blood pressure measurement and a blood-oxygen concentration measurement.

10. The method of claim 1, further comprising capturing the at least one of anatomical and physiological information with a minimally invasive medical device.

11. The method of claim 1, further comprising displaying instrumentation information on the display.

12. The method of claim 1, wherein the second image and the boundary are each displayed in a different color.

13. A medical display system, comprising:
a display having a plurality of pixels;
a first plurality of the pixels displaying medical image data;
a second plurality of the pixels displaying trace signal data, and
a third plurality of the pixels disposed between the first and second pluralities of pixels, the third plurality of pixels excluding the medical image data.

14. The system of claim 13, wherein the third plurality of pixels is symmetrically disposed about the second plurality of pixels.

15. The system of claim 14, wherein the second plurality of pixels has a width of approximately three pixels, and the third plurality of pixels has a width of approximately ten pixels.

16. The system of claim 13, wherein the second plurality of pixels divides the first plurality of pixels into two separate sections.

17. The system of claim 13, wherein the trace signal data includes a measurement of cardiac electrical activity.

18. The system of claim 13, further comprising an image acquisition device coupled to the display.

19. The system of claim 18, further comprising a physiological assessment device coupled to at least one of the display and the image acquisition device.

20. The system of claim 19, wherein at least one of the image acquisition device and the physiological assessment device includes a catheter having an electrode.

21. The system of claim 13, further comprising a fourth plurality of the pixels displaying a background, wherein the third plurality of pixels and the fourth plurality of pixels have substantially the same color.

22. A medical imaging system, comprising:
a medical image acquisition device;
a physiological assessment device;
a display coupled to the medical image acquisition device and the physiological assessment device, the display displaying:
a medical image obtained from the medical image acquisition device;
a physiological measurement obtained from the physiological assessment device, the physiological measurement segmenting the medical image on the display; and
a border substantially surrounding the physiological measurement, the border defining a region of the display excluding the medical image.

23. The system of claim 22, wherein the display displays a background, and wherein the background and the border have substantially the same color.

24. The system of claim 22, wherein the physiological measurement is at least one of an electrocardiogram and an electrogram.

25. The system of claim 22, wherein the physiological measurement includes at least one of a blood pressure measurement and an oxygen saturation measurement.

26. The system of claim 22, wherein the medical image includes a portion of a heart.
